(19) United States
(12) Patent Application Publication
(10) Pub. No.: US 2013/0115484 A1
(43) Pub. Date: May 9, 2013

(54) LITHIUM ION SECONDARY BATTERY WITH IMPROVED SAFETY CHARACTERISTICS

(71) Applicant: JOHNSON CONTROLS TECHNOLOGY LLC, Wilmington, DE (US)

(72) Inventors: Feng Li, Troy, MI (US); Frederic C. Bonhomme, Thiensville, WI (US); David A. Wynn, Glendale, WI (US); Jeffrey L. Swoyer, Port Washington, WI (US); Stephen M. Trate, Saugatuck, WI (US); Qingfang Shi, Brookfield, WI (US); Thomas M. Watson, Milwaukee, WI (US)

(73) Assignee: JOHNSON CONTROLS TECHNOLOGY LLC, Wilmington, DE (US)

(21) Appl. No.: 13/647,828

(22) Filed: Oct. 9, 2012

Related U.S. Application Data
(60) Provisional application No. 61/555,242, filed on Nov. 3, 2011.

(51) Int. Cl. H01M 2/16; H01M 4/04

(52) U.S. Cl. 429/50; 429/247; 429/251; 29/623.5

(57) ABSTRACT

A lithium ion secondary battery is provided. The battery comprises: an electrolytic solution; a negative electrode comprising a negative electrode active material; a positive electrode comprising a positive electrode active material, and a heat-resistant layer comprising a metal fluoride.

### CROSS REFERENCE TO RELATED APPLICATIONS

The present application claims the benefit of priority from U.S. Provisional patent application No. 61/555,242 entitled “LITHIUM ION SECONDARY BATTERY WITH IMPROVED SAFETY CHARACTERISTICS” and filed on 3 Nov. 2011, the contents of which are hereby incorporated by reference in their entirety to the extent permitted by law.

### BACKGROUND

In recent years, there has been an increasing demand for a rechargeable battery that can be repeatedly charged and discharged as a power source for portable electronic devices such as laptop computers, mobile telephones, and liquid crystal televisions, as well as for electric vehicles. Lithium ion secondary batteries, which are lightweight and have high energy density, are widely used as power sources for various electric and electronic devices. In general, a battery should be stable at a high temperature and have good charge and discharge, cycle life, and high rate characteristics.

Lithium ion secondary batteries usually include a positive electrode, a negative electrode, and a separator. The separator is interposed between the positive electrode and the negative electrode in order to electrically insulate the positive electrode from the negative electrode and to hold an electrolyte for establishing an ionic current between the electrodes. Commonly used separators include microporous films comprising a polyolefin resin such as polyethylene and polypropylene. When a microporous polymeric film is exposed to high temperatures, these pores are closed. This is called the shut-down function of the film. A lithium battery may be designed such that the shutdown function is fulfilled at a temperature close to 130° C. by including polyethylene, or at a temperature close to 160° C. when using polypropylene, in the separator. Such separators are commonly available from a number of commercial manufacturers.

However, microporous polymeric films have a tendency to melt and shrink when exposed to high temperatures, such as when a battery is placed under a high temperature for extended periods of time, when an internal short circuit occurs or when a sharp-shaped object penetrates through the battery. The melting and shrinkage of the porous film may cause a direct contact between the positive electrode and the negative electrode. Once an internal short-circuit occurs, the short-circuit current produces Joule's heat, so that the temperature of the short-circuited portion may locally exceed the melting point of the material of the porous film to cause an expansion of the short-circuited portion, thereby leading to overheating of the battery. Such expansion of the short circuit portion generates further reaction heat, thereby accelerating an abnormal overheat of the battery. A large amount of heat can also be generated when overcharging a high capacity battery. Although the separator may be designed to close its micro-pores in response to overheating, the amount of over-current-generated heat may cause the separator to be in a continuous melted state, thereby increasing the likelihood of an internal electrical short.

Traditionally, two main approaches have been applied in order to prevent such overheating. The first such approach relies on a porous, heat-resistant ceramic separator formed by combining particles of ceramic filler with a heat-resistant binder. Customary ceramic separators include metal oxides, such as alumina (Al₂O₃) or magnesia (MgO) particles to form the ceramic filler. The second approach involves the formation of a porous heat-resistant layer including metal oxide powders on the surface of a negative electrode or a positive electrode by a coating technology. Heat-resistant separators and/or layer prevent a positive electrode and a negative electrode from being brought into contact with each other even if a high temperature is generated and the polymeric separator melts.

For lithium ion batteries, LiPF₆ has been one preferred choice for the electrolyte solute in state-of-the-art lithium ion batteries owing to its ability to provide high ionic conductivity, to passivate aluminum current collectors of the positive electrode, and to favor the formation of a solid electrolyte interface (SEI) on the surface of a graphite electrode. Unfortunately, LiPF₆ is highly sensitive to moisture and is thermally unstable. In this regard, it has been proven that LiPF₆ is one the major causes for capacity fading of lithium ion batteries due to its hydrolysis producing hydrofluoric acid (HF). This HF subsequently promotes dissolution of the metal oxide fillers. This in turn may lead to ceramic layers being unable to effectively improve the thermal shrinkage of separators following long-term storage of batteries.

### SUMMARY

In a first aspect, a lithium ion secondary battery is provided. The battery comprises: an electrolytic solution; a negative electrode comprising a negative electrode active material; a positive electrode comprising a positive electrode active material, and a heat-resistant layer comprising a metal fluoride.

In a second aspect, a method of generating electric current is provided. The method comprises electrically connecting the positive electrode and the negative electrode of a lithium ion secondary battery comprising: an electrolytic solution; a negative electrode comprising a negative electrode active material; a positive electrode comprising a positive electrode active material, and a heat-resistant layer comprising a metal fluoride.

In a third aspect, a heat-resistant battery layer is provided. The layer comprises particles comprising a metal fluoride, and a matrix material, the layer having a thickness of about 0.5 micrometers to about 50 micrometers.

In a fourth aspect, a method for manufacturing a heat-resistant layer is provided. The method comprises the steps of: forming a mixture comprising metal fluoride particles, a matrix material, and a solvent, and applying the mixture to an electrode surface.

### BRIEF DESCRIPTION OF THE FIGURES

FIG. 1 illustrates a cross-sectional view of a battery separator.

FIG. 2 illustrates a cross-sectional scheme of a combined electrode plate.

FIG. 3 illustrates the charging/discharging characteristics of a lithium ion secondary battery with a magnesium fluoride ceramic coating on the negative electrode surface.

FIG. 4 illustrates the results of a hot box test on a laminated pouch battery.

FIG. 5 illustrates the results of a hot box test on a laminated pouch battery featuring a magnesium fluoride ceramic coating on the negative electrode surface.

### DEFINITIONS

As used herein, the articles “a,” “an,” “the,” and “said” are intended to mean that there are one or more of the elements referred to by an article. The terms “comprising,” “including,” and “having” are intended to be inclusive and mean that there may be additional elements other than the listed elements.

As used herein, the term “particle” means a closed object having an aspect ratio of 1:1 to 1:100. The aspect ratio of an object is the ratio of the shortest axis to the longest axis, where these axes need not be perpendicular. A particle may have any shape that falls within this aspect ratio, such as a sphere, a toroid, or an irregular ameboid shape. The surface of a particle may have any texture, for example rough or smooth. The term “average” of a dimension of a plurality of particles means the average of that dimension for the plurality. For example, the term “average diameter” of a plurality of particles means the average of the diameters of the particles, where the diameter of a single particle is the average of the diameters of that particle.

### DETAILED DESCRIPTION

The present application is based on the discovery that metal fluorides can be used to manufacture heat-resistant separators for lithium ion batteries. Such separators have been found to effectively prevent physical contact between the electrodes while being sufficiently ion-conductive to permit ion transfer between the electrodes, thereby enabling the generation of electric current. Moreover, the separators are characterized by a higher chemical durability than heat-resistant separators based on metal oxides. Without being bound to any particular theory, it is believed that this improved durability is the result of the resistance of metal fluorides to acids, and particularly to hydrofluoric acid.

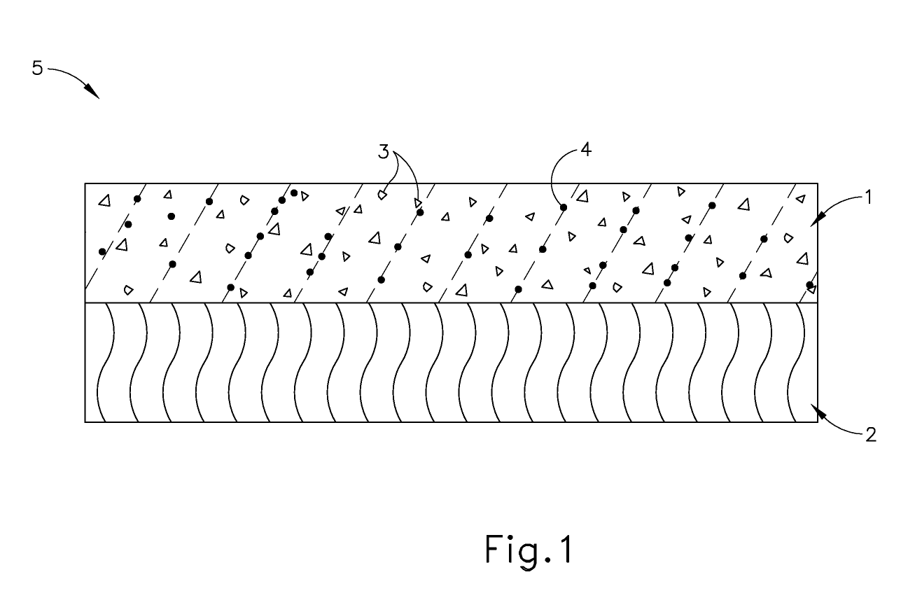

Accordingly, in one aspect, a heat-resistant layer for lithium ion batteries is provided. The layer comprises a metal fluoride and other components as may be needed to obtain a layer with the desired properties, such as matrix materials. The shape of the layer may be that of a sheet, plate, or other shapes to suit battery requirements and characteristics. FIG. 1 illustrates a schematic view in cross-section of an example separator 5 including heat-resistant layer 1 which comprises a matrix material 4 and particles 3. The matrix material 4 includes a material providing the function of surrounding and supporting the particles by maintaining their relative positions, and may include one or more heat-resistant polymers. Example heat-resistant polymers include crystalline and semi-crystalline polymers having melting points (Tₘ) of about 170° C. or higher, and amorphous polymers having a glass transition temperature (T_{g}) of about 170° C. or higher. Examples of heat-resistant polymers include polyesters such as polybutylene terephthalate and polyethylene terephthalate; fluororesins such as polyvinylidene fluoride (PVDF) and polytetrafluoroethylene (PTFE); polyamides; polyarylene sulfides; polyimides; polyamide-imides; polyether sulfone (PES); polyetheretherketone (PEEK); polycarbonates; cellulose acetate; cellulose triacetate; polysulfones; polyetherimide (PEI); polyurethane; polyethylene oxide (PEO); polyacrylonitrile (PAN); polymethylmethacrylate (PMMA); polyacrylamide; polyvinylacetate; polyvinylpyrrolidone (PVP); polyvinyl alcohol (PVA); glycol diacrylate, hexafluoropropylene (HFP), and chlorotetrafluoroethylene (CTFE). Co-polymers, for example poly(vinylidene fluoride-co-hexafluoropropene) (PVDF:HFP), are also contemplated.

The particles 3 comprise a metal fluoride. The metal fluoride of the particles includes a metal, for example one of the alkali metals, alkaline earth metals or transition metals. Example metal fluorides include LiF, NaF, KF, MgF₂, CaF₂, CuF₂, CdF₂, FeF₂, MnF₂, NiF₂, PbF₂, SnF₂, SrF₂, ZnF₂, AlF₃, BF₃, BiF₃, CeF₃, CrF₃, FeF₃, InF₃, LaF₃, MnF₃, NdF₃, YF₃, CeF₄, GeF₄, HfF₄, SiF₄, SnF₄, TiF₄, VF₄, ZrF₄, VF₅, NbF₅, SbF₅, TaF₅, BiF₅, MoF₆, ReF₆, SF₆, WF₆, and combinations thereof. Preferred metal fluorides include those of alkaline earth metals, such as calcium fluoride (CaF₂), magnesium fluoride (MgF₂), and combinations thereof. In representative cases, the average diameter of the particles may range from about 0.01 micrometers to about 50 micrometers. In some cases, it may range from about 0.5 micrometers to about 10 micrometers. In other cases, the average diameter may range from about 1 micrometer to about 5 micrometers.

The relative amounts of particles and matrix material may be chosen to suit the requirements of the battery at hand. For example, the particles may be included in an amount of 20% to 90% by weight and the matrix material in an amount of 5% to about 80% by weight, where in both instances the amounts are based on the overall weight of the heat-resistant layer. The thickness of heat-resistant layer 1 may also be tailored to suit the particular battery requirements, such as the desired distance separating the electrodes and the overall thickness of the battery at hand. In some cases, heat-resistant layer 1 may have a thickness of about 0.5 micrometers to about 50 micrometers. In other cases, heat-resistant layer 1 may have a thickness of about 1 micrometer to about 25 micrometers. In yet other cases, the thickness of heat-resistant layer 1 may be from about 2.5 micrometers to about 5 micrometers.

Regarding the porosity of heat-resistant layer 1, this feature involves both pore volume and pore size. Pore volume refers to the volume percent of a body, such as heat-resistant layer 1, occupied by pores. At least a minimum pore volume is necessary to provide sufficient electrolyte in the layer and connectivity for ion transfer. This usually means that a pore volume of at least about 40% is required for best results. Higher pore volumes, for instance in the range of 60-85%, may be used as is compatible with other factors such as mechanical strength. Pore size is significant both for its effect on pore volume and its effect on wickability. The latter is the ability of a porous body to take up a liquid by capillary action. It may be measured in terms of time for a liquid to rise to a certain level when the porous body is suspended in the liquid. Pore sizes in heat-resistant layer 1 may vary from 0.1 to 25 microns. Too large a pore size is undesirable as the battery then tends to leak, that is, to not hold the electrolyte properly. The best pore size for any application is dependent on, and influences, relative porosity, cell impedance, required battery performance characteristics and choice of metal fluoride particles.

The battery separator 5 may include other layers in addition to the heat-resistant layer 1, for instance one or more microporous polymer layers. The polymers included in such layers may be polyolefins, such as polyethylene and polypropylene. Microporous polymer layers may also include other polymers in addition to polyolefins, such as polyethylene terephthalate (PET), polyvinylidene fluoride (PVdF), and/or a polyamide. A shutdown function may also be included in the battery separator 5. As illustrated in FIG. 1, this may take the form of a shutdown layer 2 comprising a porous material whose pores close when exposed to high temperatures. The shutdown temperature may be, for instance, about 130° C. when the shutdown layer material is polyethylene, or about 160° C. when the material is polypropylene. More generally, the chosen shutdown temperature will usually govern the choice of the material of the shutdown layer. In other words, once the required shutdown temperature or temperature range is decided, an appropriate polymer or polymer mixture may be chosen from commercially available materials or prepared on an ad hoc basis to meet the requirement. Porous polymeric separators for fulfilling the shutdown function have been made commercially available by many among the more important world producers of lithium battery parts. More than one shutdown layers may be included, for example one on each side of heat-resistant layer 1.

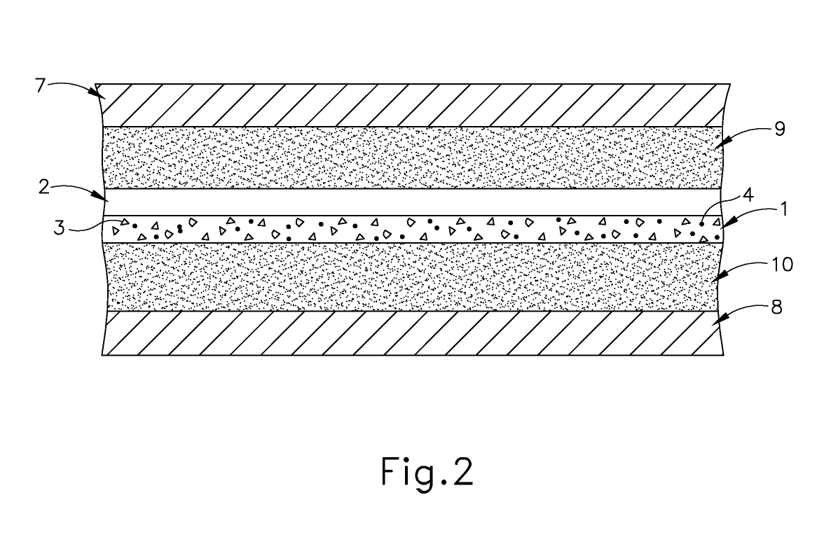

As outlined above, the heat-resistant layer 1 is particularly suited to lithium ion secondary batteries. Accordingly, in a second aspect, a battery comprising the heat-resistant layer described hereinabove is provided. FIG. 2 illustrates a schematic view in cross-section of an example combined electrode plate for such a battery. A positive electrode is formed by positive electrode material layer 9 in contact with positive electrode current collector 7, and a negative electrode by negative electrode material layer 10 in contact with negative electrode current collector 8. The above separator 5, comprising heat-resistant layer 1 and shutdown layer 2, is interposed between the electrodes. As described above, layer 1 includes particles 3 and matrix material 4. Because of their ability to safely perform at high temperatures, lithium ion secondary batteries featuring a heat-resistant layer such as 1 make practical power sources for electric vehicles (EV), hybrid electric vehicles (HEV) and other systems requiring a high energy density power source.

FIG. 2 depicts heat-resistant layer 1 as a film coated on the negative electrode material; however, other configurations are possible, the only requirement being that the heat-resistant layer prevent contact between the electrodes. For example, layer 1 may instead be coated on the positive electrode material. Also contemplated are configurations where the heat-resistant layer 1 is in contact with both electrodes, for example as a layer interposed between the electrodes and in contact with both the positive electrode and negative electrode materials. In other example configurations, there may be more than one shutdown layers, for instance two such layers sandwiching heat-resistant layer 1.

Heat-resistant layer 1 may be manufactured by forming a film mixture that includes metal fluoride particles, a matrix material, and a solvent. The film mixture is applied to a surface, such as that of an electrode plate coated with an active material, for example by dipping the surface in the film mixture. A metal fluoride layer may thus be formed on surfaces where cathode and anode plates face each other, thereby preventing an electrical short between the electrode plates while allowing ions to pass through. The solvent of the film mixture may include a first and second solvent. The first solvent has a highly ability to dissolve the matrix material and a low boiling temperature. In contrast, the second solvent has a low ability to dissolve the matrix material, but a high boiling point. Once the film mixture is applied to a surface, the first solvent evaporates, followed by the second solvent, thereby forming heat-resistant layer 1.

The positive electrode active material may include any material that can sufficiently undergo lithium intercalation and deintercalation while functioning as the positive terminal of a lithium ion battery. The positive electrode active material may also include a binder material to structurally hold the lithium-based active material together. One common class of known materials that can be used to form the positive electrode active material is layered lithium transitional metal oxides. For example, the positive electrode active material may comprise at least one of spinel lithium manganese oxide (LiMn₂O₄), lithium cobalt oxide (LiCoO₂), a nickel-cobalt-manganese oxide [Li(NiₓCo_{y}Mn_{z})O₂], or a lithium iron polyanion oxide such as lithium iron phosphate (LiFePO₄) or lithium iron fluorophosphate (Li₂FePO₄F) intermingled in at least one of polyvinyldiene fluoride (PVdF), an ethylene propylene diene monomer (EPDM) rubber, or carboxymethoxyl cellulose (CMC). Other lithium-based materials may also be utilized besides those just mentioned. Those alternative materials include, for example, lithium nickel oxide (LiNiO₂), lithium aluminum manganese oxide (LiₓAl_{y}Mn_{1-y}O₂), and lithium vanadium oxide (LiV₂O₅). The positive electrode current collector may be made of aluminum or of a conductive material compatible with the other elements of the battery.

The negative electrode active material may include any lithium host material that can sufficiently undergo lithium intercalation and de-intercalation while functioning as the negative terminal of a lithium ion battery. The negative electrode material may also include a polymer binder material to structurally hold the lithium host material together. For example, the negative electrode may be formed from graphite intermingled in at least one of polyvinyldiene fluoride (PVdF), a styrene butadiene rubber (SBR), or carboxymethoxyl cellulose (CMC). Graphite is widely utilized to form the negative electrode because it exhibits favorable lithium intercalation and deintercalation characteristics, is relatively non-reactive, and can store lithium in quantities that produce a relatively high energy density. Forms of graphite that may be used to fabricate the negative electrode material are available from a number of commercial producers. Other materials can also be used to form the negative electrode including, for example, lithium titanate. The negative electrode current collector may be formed from copper or any other appropriate electrically conductive material compatible with the other elements of the battery.

Any appropriate electrolyte solution that can conduct lithium ions between the negative electrode and the positive electrode may be used in the lithium ion battery. The electrolyte solution may be a non-aqueous liquid electrolyte solution that includes a lithium salt dissolved in an organic solvent or a mixture of organic solvents. A non-limiting list of lithium salts that may be dissolved in an organic solvent to form the non-aqueous liquid electrolyte solution include LiClO₄, LiAlCl₄, LiI, LiBr, LiSCN, LiBF₄, LiB(C₆H₅)₄ LiAsF₆, LiCF₃SO₃, LiN(CF₃SO₂)₂, LiPF₆, and combinations thereof. The above-described heat-resistant layer 1 is especially suited to salts that include fluorine, such as LiPF₆. These lithium salts may be dissolved in a variety of organic solvents such as: cyclic carbonates (ethylene carbonate (EC), propylene carbonate, butylene carbonate), acyclic carbonates (dimethylcarbonate (DMC), diethyl carbonate, ethylmethylcarbonate (EMC)), aliphatic carboxylic esters (methyl formate, methyl acetate, methyl propionate), γ-lactones (γ-butyrolactone, γ-valerolactone), chain structure ethers (1,2-dimethoxyethane, 1-2-diethoxyethane, ethoxymethoxyethane), cyclic ethers (tetrahydrofuran, 2-methyltetrahydrofuran), and mixtures thereof.

### EXAMPLES

### Example 1

To prepare a positive electrode, N-methyl-2-pyrrolidone was added to a mixture comprising lithium salt Li[Ni_{1/3}Co_{1/3}Mn_{1/3}]O₂, acetylene black, which is an amorphous carbon material, as an electrically conductive agent, and polyvinylidene fluoride as a binder in a ratio by weight of 92:4:4, to make a positive electrode active material slurry. This slurry was applied onto both sides of a positive electrode core member comprising a 20 micrometers thick aluminum foil, dried, and rolled, to form a positive electrode with positive electrode active material layers. Artificial graphite, styrene-butadiene rubber as a binder and carboxymethyl cellulose as a thickening agent were mixed in the weight ratio of 94:3:3, and the resulting mixture was dispersed in water to form a negative electrode active material slurry. This slurry was coated on copper foil having a thickness of 15 micrometers, dried and rolled to provide a negative electrode.

A heat-resistant layer raw material paste was prepared by stirring 92 wt % of magnesium fluoride particles with an average diameter of 0.4 micrometers, 8 wt % of polyvinylidene fluoride: hexafluoropropylene (PVDF:HFP), and a suitable amount of NMP with a mixing roller. This raw material paste was applied onto the surfaces of the negative electrode and dried under reduced pressure at 120° C. to form a heat-resistant first layer less than 4 micrometers thick.

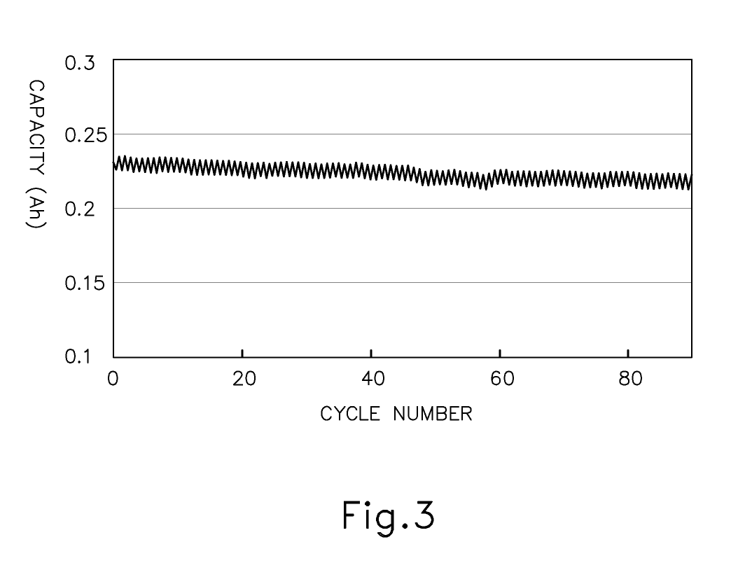

The positive and negative electrodes obtained as described above were slid and stacked with a second polyethylene layer. The electrode stacks were sealed by laminated aluminum foil pouches. An electrolyte was injected into the pouch to provide a lithium rechargeable battery. The electrolyte was a mixed solvent of ethylene carbonate (EC), dimethyl carbonate (DMC), and ethyl methyl carbonate (EMC) in a volume ratio of 1:1:1, containing 1M LiPF₆ dissolved therein. The charging/discharging characteristics of the resulting lithium secondary battery with the magnesium fluoride coating on the negative electrode surface were examined at 1 C rate and room temperature, and the test results are shown in FIG. 3.

### Example 2

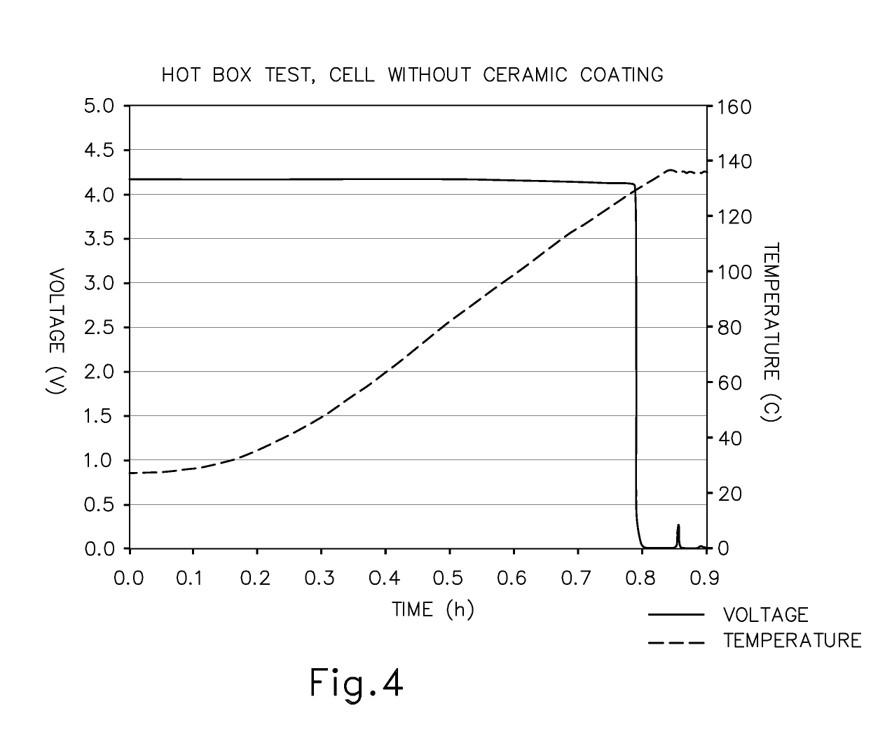

A pouch lithium secondary battery was produced in the same manner as the battery of Example 1, except that no heat-resistant layer was present. FIG. 4 illustrates the hot box test results of the laminated pouch battery. The pouch battery was charged to a voltage 4.2 V and then placed in the hot box. The hot box temperature was ramped at a rate of 5° C./min from room temperature to a final temperature of 140° C. which was maintained for 20 minutes. As the polyethylene layer shrank, the battery voltage dropped to zero Volts, indicating that an internal short circuit occurred. The battery thus became unsafe and lost its capacity.

### Example 3

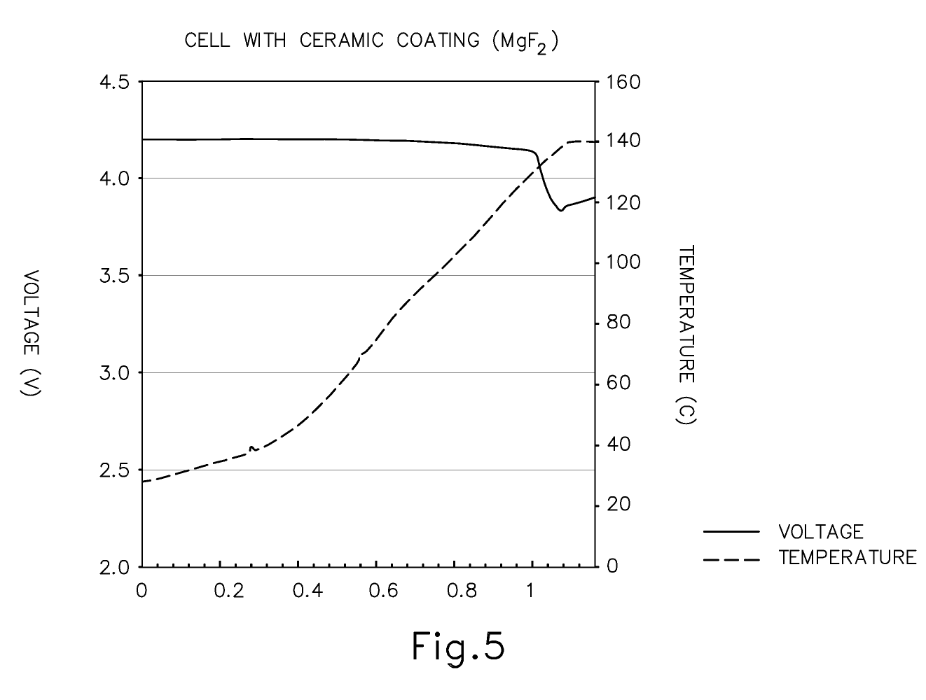

A pouch lithium secondary battery was produced in the same manner as the battery of Example 1. The battery featured a magnesium fluoride layer coated on the negative electrode surface. The hot box treatment was the same as in Example 2. The results are illustrated in FIG. 5. With the magnesium fluoride layer between the electrodes, the battery did not experience an internal short circuit. Rather, the battery kept its capacity and was much safer than the battery of Example 2, which, as explained above, lacked the magnesium fluoride layer.

1. A lithium ion secondary battery, comprising:
an electrolytic solution;
a negative electrode comprising a negative electrode active material;
a positive electrode comprising a positive electrode active material, and
a heat-resistant layer comprising a metal fluoride.

2. The lithium ion secondary battery of claim 1, wherein the metal fluoride is selected from the group consisting of LiF, NaF, KF, MgF₂, CaF₂, CuF₂, CdF₂, FeF₂, MnF₂, NiF₂, PbF₂, SnF₂, SrF₂, ZnF₂, AlF₃, BF₃, BiF₃, CeF₃, CrF₃, FeF₃, InF₃, LaF₃, MnF₃, NdF₃, YF₃, CeF₄, GeF₄, HfF₄, SiF₄, SnF₄, TiF₄, VF₄, ZrF₄, VF₅, NbF₅, SbF₅, TaF₅, BiF₅, MoF₆, ReF₆, SF₆, WF₆, and combinations thereof.

3. The lithium ion secondary battery of claim 1, wherein the heat-resistant layer comprises particles comprising a metal fluoride.

4. The lithium ion secondary battery of claim 3, wherein the particles have an average diameter of about 0.01 micrometers to about 50 micrometers.

5. The lithium ion secondary battery of claim 3, wherein the particles have an average diameter of about 0.5 micrometers to about 10 micrometers.

6. The lithium ion secondary battery of claim 3, wherein the heat-resistant layer comprises from about 20% to about 90% by weight of the particles.

7. The lithium ion secondary battery of claim 1, wherein the heat-resistant layer further comprises a matrix material.

8. The lithium ion secondary battery of claim 7, wherein the matrix material is a polymer selected from the group consisting of polyvinylidene fluoride (PVDF), polyurethane, polyethylene oxide, polyacrylonitrile, polymethylacrylate, polyacrylamide, polyvinylacetate, polyvinylpyrrolidone, polyvinyl alcohol polytetrafluoroethylene, glycol diacrylate, hexafluoropropylene (HFP), chlorotetrafluoroethylene (CTFE), and combinations thereof.

9. The lithium ion secondary battery of claim 7, wherein the heat-resistant layer comprises from about 5% to about 80% by weight of the matrix material.

10. The lithium ion secondary battery of claim 1, wherein the heat-resistant layer has a thickness from about 0.5 micrometers to about 50 micrometers.

11. The lithium secondary battery of claim 1, further comprising a shutdown layer.

12. The lithium secondary battery of claim 11, wherein the shutdown layer comprises a material selected from the group consisting of polyethylene, polypropylene, and combinations thereof.

13. A method of generating electric current, comprising electrically connecting the positive electrode and the negative electrode of the lithium ion secondary battery of claim 1.

14. A vehicle comprising the lithium ion secondary battery of claim 1.

15. A heat-resistant battery layer comprising: particles comprising a metal fluoride, and a matrix material, the layer having a thickness of about 0.5 micrometers to about 50 micrometers.

16. The heat-resistant battery layer of claim 15, having a thickness of about 1 micrometer to about 25 micrometers.

17. The heat-resistant battery layer of claim 15, having a thickness of about 2.5 micrometers to about 5 micrometers.

18. The heat-resistant battery layer of claim 15, comprising from about 20% to about 90% by weight of the particles.

19. The heat-resistant battery layer of claim 15, wherein the metal fluoride is selected from the group consisting of LiF, NaF, KF, MgF₂, CaF₂, CuF₂, CdF₂, FeF₂, MnF₂, NiF₂, PbF₂, SnF₂, SrF₂, ZnF₂, AlF₃, BF₃, BiF₃, CeF₃, CrF₃, FeF₃, InF₃, LaF₃, MnF₃, NdF₃, YF₃, CeF₄, GeF₄, HfF₄, SiF₄, SnF₄, TiF₄, VF₄, ZrF₄, VF₅, NbF₅, SbF₅, TaF₅, BiF₅, MoF₆, ReF₆, SF₆, WF₆, and combinations thereof.

20. The heat-resistant battery layer of claim 15, wherein the matrix material is a polymer selected from the group consisting of polyvinylidene fluoride, polyurethane, polyethylene oxide, polyacrylonitrile, polymethylacrylate, polyacrylamide, polyvinylacetate, polyvinylpyrrolidone, polyvinyl alcohol polytetrafluoroethylene, glycol diacrylate, hexafluoropropylene, chlorotetrafluoroethylene, and combinations thereof.

21. The heat-resistant battery layer of claim 15, comprising from about 5% to about 80% by weight of the matrix material.

22. The heat-resistant battery layer of claim 15, wherein the particles have an average diameter of about 0.01 micrometer to about 50 micrometers.

23. A method for manufacturing a heat-resistant layer, comprising the steps of:
forming a mixture comprising metal fluoride particles, a matrix material, and a solvent, and
applying the mixture to an electrode surface.

24. The method of claim 23, wherein the surface is a surface of an electrode selected from the group consisting of a positive electrode, and a negative electrode.

25. The method of claim 23, wherein the solvent comprises a first solvent and a second solvent having a boiling point higher than a boiling point of the first solvent.
